(19) United States
(12) Patent Application Publication
(10) Pub. No.: US 2004/0081126 A1
(43) Pub. Date: Apr. 29, 2004

(54) De-channelization method of W-CDMA system

(75) Inventor: Seok-Il Chang, Gyeonggi-Do (KR)

Correspondence Address: FLESHNER & KIM, LLP, P.O. BOX 221200, CHANTILLY, VA, 20153, US

(73) Assignee: LG ELECTRONICS INC.

(21) Appl. No.: 10/670,464

(22) Filed: Sep. 26, 2003

(30) Foreign Application Priority Data
Sep. 28, 2002 (KR) 59103/2002

(51) Int. Cl. H04B 7/216

(52) U.S. Cl. 370/335; 370/342

(57) ABSTRACT

A system and method de-channelizes data in a W-CDMA system which uses an OVSF code. The method includes detecting an OVSF code used as a channelization code, demodulating data multiplexed in the OVSF code using an FHT, and mapping the order of the demodulated data so that it corresponds to the OVSF code. By restoring multiplexed data using FHT (Fast Hadamard Transform), complexity of calculations can be reduced and data can be quickly restored.

### BACKGROUND OF THE INVENTION

1. Field of the Invention

The present invention generally relates to communications systems, and more particularly to system and method for processing signals transmitted in a W-CDMA system.

2. Background of the Related Art

A W-CDMA (Wide-Code Division Multiple Access) is a communication standard used to support the Europe-based asynchronous IMT-2000 service. This service is a third-generation (3G) technique which heightens data transfer rates and is compatible with existing CDMA networks, instead of time-division multiple access (TDMA) networks used for the European global system for mobile communication (GSM) standard.

The W-CDMA standard requires various rates of data transmission. In an asynchronous W-CDMA system, traffic channels are identified using a spreading factor (SF) expressed in a form of an exponent of 2 from 1 to 512. Also, in W-CDMA, a channelization code is multiplied in order to discriminate channels that are simultaneously transmitted in a forward link and a reverse link, and in this case an orthogonal variable spreading factor (OVSF) code is generally used.

FIG. 1 illustrates a code tree structure for generating an OVSF code defined in a W-CDMA standard. The OVSF code is formed from two values, namely +1 and −1. The channelization code length of each OVSF code and the number of available codes are the same as a corresponding spreading factor. A data transmission method in W-CDMA will now be described.

A transmitting unit code division initially multiplexes a series of data to be transmitted using a specific SF and a plurality of channelization codes. The multiplexed data is then transmitted to a receiving unit, which restores the data received from the transmitting unit by multiplying the channelization codes used for multiplexing each data to each received corresponding data.

In related-art W-CDMA systems in which data is transmitted using plural channelization codes having the same SF, the amount of required calculations is very large. This is because the channelization code is multiplied to each data in order to restore the original data. Also, the calculations are very complicated because as the SF becomes bigger the length and the number of the channelization codes are increased.

### SUMMARY OF THE INVENTION

An object of the present invention is to provide a system and method for de-channelizing OVSF code-channelized data in a W-CDMA system in a faster and more computationally efficient manner than other techniques which have been proposed.

Another object of the present invention is to provide a system and method for de-channelizing OVSF code-channelized data using a fast Hadamard Transform (FHT) algorithm.

To achieve these and other objects and advantages, the present invention provides a de-channelization method for a W-CDMA system which in accordance with one embodiment includes: detecting an OVSF code used as a channelization code; demodulating data multiplexed in the OVSF code by using the FHT; and mapping the order of the demodulated data in order to correspond it to the OVSF code.

In accordance with another embodiment, the present invention provides a de-channelization method of a W-CDMA system including: detecting an SF value of an OVSF code which has multiplexed data; demodulating the data by using FHT; extracting a mapping number sequence corresponding to the SF value from a mapping table; and arranging the demodulated data in order of the mapping number sequence.

In accordance with another embodiment, the present invention provides a de-channelization method of a W-CDMA system including: detecting an SF value (SF=2^{m}) of an OVSF code which has multiplexed data; demodulating the data by using FHT; extracting the odd numbered elements from the mapping number sequence of the OVSF code for uppermost SFs (256=2⁸) and generating a mapping number sequence corresponding to the SF value (SF=2^{m}); and arranging each demodulated data in order of the generated mapping number sequence.

In accordance with another embodiment, the present invention provides a de-channelization method of a W-CDMA system including: detecting an SF(2^{m}) value of an OVSF code which has multiplexed data; demodulating the data by using FHT; directly generating a mapping number sequence (M={m₁, m₂, m₃, . . . m_{SF}}) for the SF(2^{m}) of the OVSF code; and arranging each demodulated data in order of the generated mapping number sequence.

### BRIEF DESCRIPTION OF THE DRAWINGS

FIG. 1 illustrates a code tree structure for generating an OVSF code;

FIG. 2 illustrates a definition of Hadamard matrix;

FIGS. 3A and 3B illustrate an embodiment of the present invention implementing a vector through FHT;

FIG. 4 is a flow chart showing steps included in a de-channelization method of a W-CDMA system in accordance with a preferred embodiment of the present invention; and

FIG. 5 illustrates a mapping table used in accordance with the preferred embodiment of the present invention.

### DETAILED DESCRIPTION OF PREFERRED EMBODIMENTS

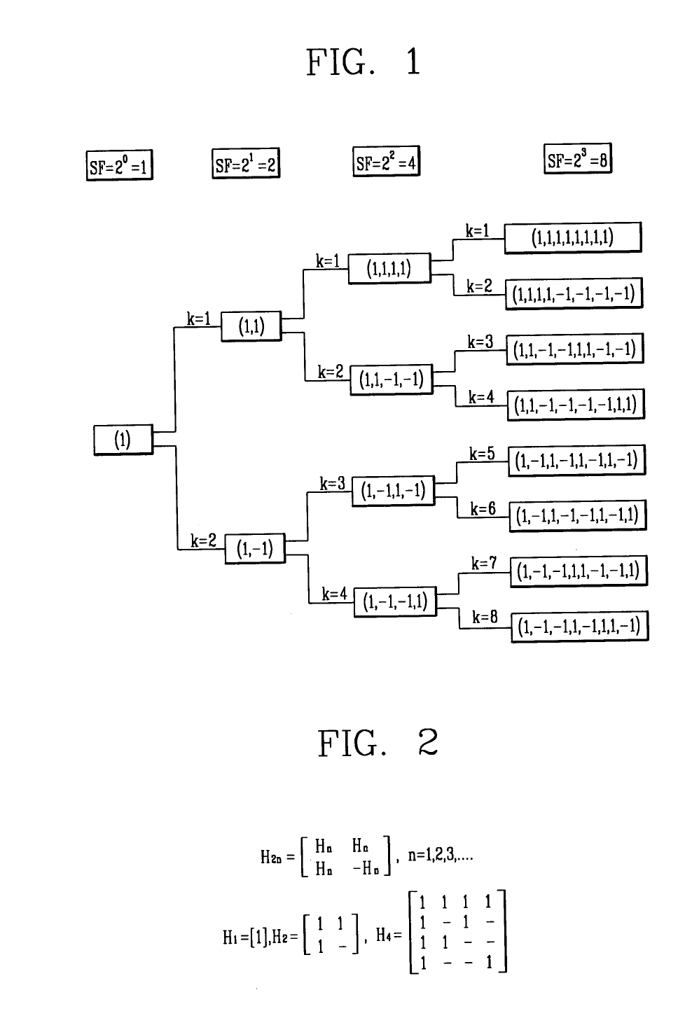

FIG. 2 illustrates a definition of a Hadamard matrix. Number sequences of each row or column of the Hadamard matrix is identical to the number sequence of an OVSF codes of FIG. 1. Equation (1) defines a Hadamard transform for multiplying the Hadamard matrix to an arbitrary vector.

\overline{F}=FHₙ (1)

wherein ‘F’ is an arbitrary vector with a length of ‘n’, Hₙ is the nth Hadamard transform matrix, and \overline{F} is Hadamard transform.

The Hadamard transform multiplies an input vector F and a vector including a Hadamard matrix, which corresponds to a process of restoring a code division multiplexed signal with the number sequence including a row of the Hadamard matrix. Because the number sequence of the row of the Hadamard matrix is identical to the OVSF code, the process of restoring data multiplexed by the OVSF code in the W-CDMA system can be implemented using the Hadamard transform.

In order to reduce the amount of calculations and effectively execute the Hadamard transform, a high speed algorithm called a fast Hadamard transform is used. The fast Hadamard transform (FHT) is advantageous because it can reduce the amount of calculations generated during the process of performing the Hadamard transform on a vector with the length of ‘n’, from n² to nlog₂n.

The FHT can be defined as shown in Equation (2):

H₂_{^{m}}=M₂_{^{m}}⁽¹⁾M₂_{^{m}}² . . . M₂_{^{m}}^{(m)}M₂_{^{m}}⁽ⁱ⁾=I₂_{^{m-i}} [symbol] H₂ [symbol] I₂_{ⁱ⁻¹} (2)

where In is an identity matrix. As an example, an FHT on a vector with a length of 4 Is defined by below equation (3) and calculated roughly by two steps:

FH₄=FM₄⁽¹⁾M₄⁽²⁾ (3)

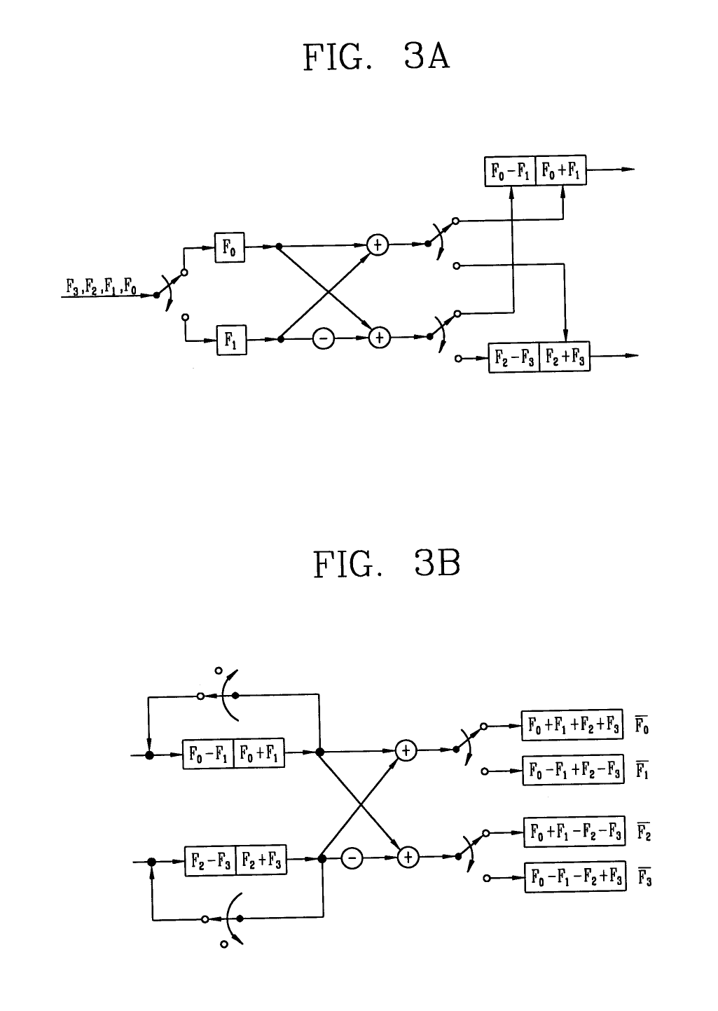

FIGS. 3A and 3B illustrate how an FHT may be implemented on a vector with a length of 4. A first step involves calculating FM₄⁽¹⁾, and a second step involves calculating (FM₄⁽¹⁾)M₄⁽²⁾ using a result value of the first step.

A comparison of values output through the FHT with the Hadamard matrix for an OVSF code with an SF length of 4 shows that the values output through FHT are identical to a number sequence including the row of the Hadamard matrix of the OVSF code, but its order is different. In other words, if the order of \overline{F₂} and \overline{F₃} is mutually changed, the order is identical to the order of the OVSF code. Thus, in case of restoring data multiplexed by the OVSF code using the FHT, a mapping should be performed so that the order of result values output through FHT corresponds to the OVSF code.

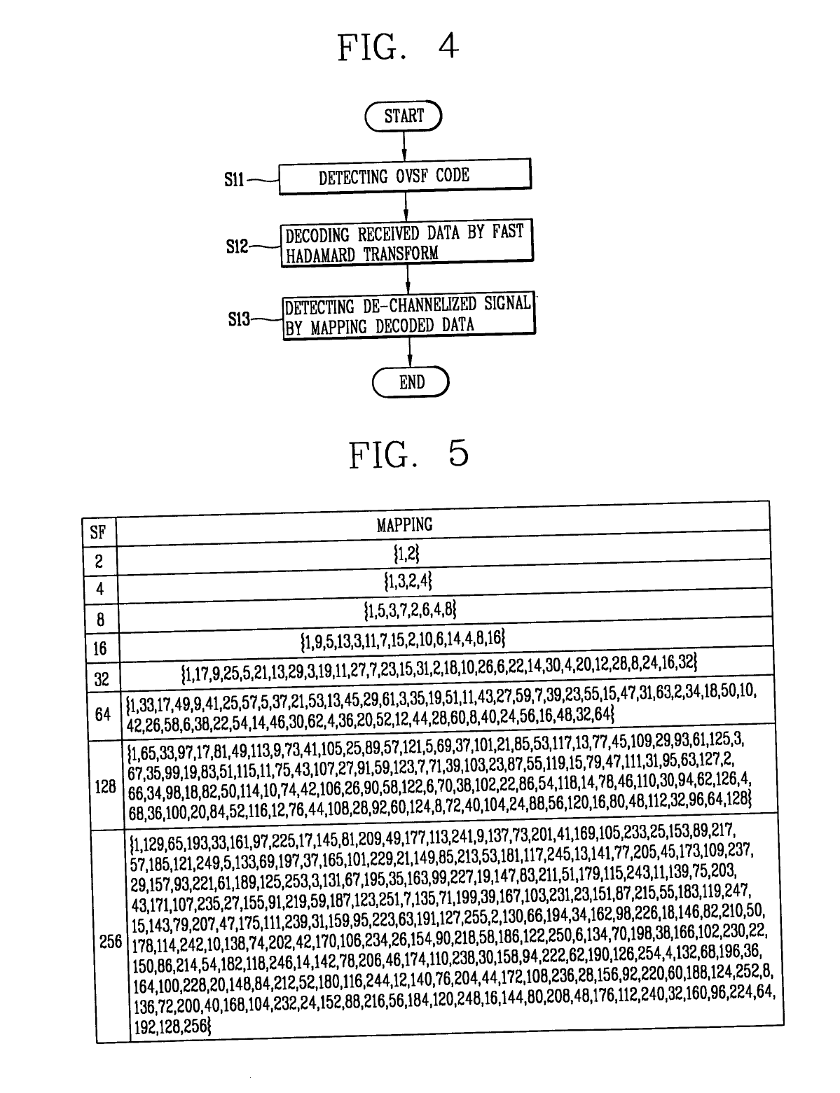

FIG. 4 is a flow chart showing steps included in a de-channelization method performed in a W-CDMA system in accordance with a preferred embodiment of the present invention. In this embodiment, multiplexed data is restored using the OVSF code. First, an OVSF code used as a channelization code of data received from a transmitting unit is detected (step S11), and the received data is de-channelized through FHT (step S12). Next, the order of each data output through FHT is mapped in order to correspond to the order of the OVSF code (step S13), and arranged in order, thereby restoring the data multiplexed in the OVSF code.

Three methods may be used for mapping data output through FHT, each of which will now be described in detail.

First, data is mapped through a mapping table, in which output values of the FHT are arranged in order of the OVSF code. FIG. 5 illustrates a mapping table of this type detected through a mock experiment. Signals multiplexed in the OVSF code are de-channelized through FHT, and when its output values are arranged in order as shown in FIG. 5 data de-channelized in order of the OVSF code is outputted.

Second, data is mapped using a mapping number sequence for SF=256, as shown in FIG. 5. Each mapping number sequence in FIG. 5 has certain characteristics such as follows. That is, in FIG. 5, mapping number sequences of SF=2^{m-1} are number sequences arranged by selecting only odd numbered values from the mapping number sequence of SF=2^{m}. In other words, the mapping number sequence {1, 3, 2, 4} for SF=2²=4 is identical to a number sequence formed by extracting only 1st, 3^{rd}, 5^{th} and 7^{th} elements from a mapping number sequence {1, 5, 3, 7, 2, 6, 4, 8} for SF=2³=8. Because mapping number sequences for every SF have such characteristics, with a mapping number sequence for SF=256, mapping number sequences for every SF can be generated.

Third, a mapping number sequence is directly calculated for mapping, rather than storing the mapping table as shown in FIG. 5.

The mapping number sequence for SF=2m may be expressed by Equation (4):

$${m}_{k} = 1 + {\sum }_{i = 0}^{m - 1} {k}_{i} \cdot {2}^{m - 1 - i} \qquad ( 4 )$$

wherein kᵢ is a binary expression value of k−1 in consideration of an element factor k of a number sequence ‘M’. More specifically, the binary expression value of k-1 for calculating the kth element mₖ of the number sequence ‘M’ may be expressed by Equation (5):

k−1=kₘ₋₁·2m⁻¹+kₘ₋₂·2^{m-2}+ . . . +k₀2⁰k−1 [symbol] (kₘ₋₁kₘ₋₂ . . . k₀) (5)

In the case of directly calculating a mapping number sequence using Equation (4), it is first determined which element of a corresponding number sequence is to be calculated. Second, a binary expression value related to the corresponding element is obtained, and then the binary expression value and the SF value are applied to Equation (4), thereby implementing a mapping number sequence.

For example, the 6^{th} element m₆ in the mapping number sequence for SF=2⁴=16 may be calculated as follows:

k−1=6−1 [symbol] (0101)

$${m}_{6} = 1 + {\sum }_{i = 0}^{4 - 1} {k}_{i} \cdot {2}^{4 - 1 - i} = 1 + 1 \cdot {2}^{3} + 0 \cdot {2}^{2} + 1 \cdot {2}^{1} + 0 \cdot {2}^{0} = 11 \qquad ( 6 )$$

The thusly calculated value of m₆ is identical to the 6^{th} element value of the mapping number sequence of SF=16 in FIG. 5. Other mapping number sequences can be calculated in such a manner.

Accordingly, by using Equation (4), a mapping can be performed on fast Hadamard transformed data even without storing a mapping table.

As so far described, the de-channelization method of a W-CDMA system has at least the following advantages. In a W-CDMA system, code-division multiplexed data is restored through FHT using an OVSF code. As a result, the complexity of calculations are reduced and data can be quickly restored.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method for de-channelizing data in a W-CDMA system, comprising:
detecting an OVSF code used as a channelization code;
demodulating data multiplexed in the OVSF code using an FHT; and
mapping an order of the demodulated data to correspond the data to the OVSF code.

2. The method of claim 1, wherein the detecting step includes detecting a spreading factor (SF) value of the OVSF code.

3. The method of claim 1, wherein the mapping step includes mapping an output FHT value using a mapping table storing the order of the OVSF code.

4. The method of claim 3, wherein the mapping table stores a mapping number sequence for each SF of the OVSF code.

5. The method of claim 1, wherein the mapping step comprises:
extracting odd numbered elements from the mapping number sequence of the OVSF code for an uppermost SF and generating a new mapping number sequence corresponding to the SF of the OVSF; and
applying an output value of the FHT in an order of the new mapping number sequence.

6. The method of claim 5, wherein the uppermost SF is 256 (2⁸).

7. The method of claim 1, wherein the mapping step comprises:
directly generating a mapping number sequence for SF(2^{m}) of the OVSF code; and
applying the generated mapping number sequence to the output value of FHT.

8. The method of claim 7, wherein the mapping number sequence is directly generated based on a mathematical expression which calculates each element of a mapping number sequence M={m₁, m₂, m₃, . . . , m_{SF}} for SF(2^{m}), said mathematical expression including:
$${m}_{k} = 1 + {\sum }_{i = 0}^{m - 1} {k}_{i} \cdot {2}^{m - 1 - i} , where k = 1 , 2 , … , SF .$$

9. The method of claim 8, wherein kᵢ is a binary expression value for k-1.

10. A method for de-channelizing detain of a W-CDMA system, comprising:
detecting an SF value of an OVSF code which has multiplexed data;
demodulating the data using an FHT;
extracting a mapping number sequence corresponding to the SF value from a mapping table; and
arranging the demodulated data in an order of the mapping number sequence.

11. The method of claim 10, wherein the mapping table stores mapping number sequences for every SF.

12. A de-channelization method for a W-CDMA system, comprising:
detecting an SF value (SF=2^{m}) of an OVSF code which has multiplexed data;
demodulating the data using FHT;
extracting odd numbered elements from the mapping number sequence of the OVSF code for uppermost SFs (256=2⁸) and generating a mapping number sequence corresponding to the SF value (SF=2^{m}); and
arranging each demodulated data in an order of the generated mapping number sequence.

13. The method of claim 12, wherein the odd numbered element is an
$${\sum }_{k = 0}^{SF - 1} ( 1 + k \cdot {2}^{8 - m} )$$
element of a mapping number sequence for the uppermost SFs.

14. A de-channelization method for a W-CDMA system, comprising:
detecting an SF(2^{m}) value of an OVSF code which has multiplexed data;
demodulating the data using a FHT;
directly generating a mapping number sequence (M={m₁, m₂, m₃, . . . , m_{SF}}) for the SF(2^{m}) value of the OVSF code; and
arranging each demodulated data in an order of the generated mapping number sequence.

15. The method of claim 14, wherein a mathematical expression used to calculate each element of the mapping number sequence is
$${m}_{k} = 1 + {\sum }_{i = 0}^{m - 1} {k}_{i} \cdot {2}^{m - 1 - i} ,$$
wherein k=1, 2, . . . , SF.

16. The method of claim 15, wherein kᵢ is a binary expression value for k−1.
